(19) United States
(12) Patent Application Publication
(10) Pub. No.: US 2026/0241646 A1
(43) Pub. Date: Aug. 20, 2026

(54) RESIN INFUSION TOOL AND METHODS OF INFUSING RESIN

(71) Applicant: The Boeing Company, Arlington, VA (US)

(72) Inventors: William L. Serencsits, Hollywood, SC (US); Manning Scarfe, Ascot Vale (AU); Jessica Offutt Fry, Charleston, SC (US)

(21) Appl. No.: 19/057,543

(22) Filed: Feb. 19, 2025

(51) Int. Cl. B29C 70/48; B29C 70/44; B29L 31/30

(52) U.S. Cl. CPC B29C 70/48; B29C 70/44; B29C 70/546; B29L 2031/3076

(57) ABSTRACT

A resin infusion tool and methods of resin infusion are presented. A resin infusion tool comprises a first tool portion of the resin infusion tool comprising a rigid material with a part infusion region and resin wells formed in the rigid material adjacent the part infusion region, and a second tool portion of the resin infusion tool comprising a rigid material and configured to seal to the first tool portion to form a part infusion chamber comprising the part infusion region.

### BACKGROUND INFORMATION

### 1. Field

The present disclosure relates generally to composite manufacturing and more specifically to resin infusion.

### 2. Background

Aerospace resins have short shelf lives at ambient temperature. Cured part standards for aerospace qualification are very strict.

Aerospace resin mixing is precise and subject to in-process monitoring. Currently, resin infusion for aerospace is injection resin infusion. Conventional resin injections for aerospace are continual injections.

Commercial resin systems for other industries can tolerate mixing of old and new resin stocks without quality concerns. Mixing of old and new resin is not a feasible solution for aerospace resins and applications. Qualification standards for aerospace composites cannot tolerate unknown concentrations of aged resin.

Therefore, it would be desirable to have a method and apparatus that takes into account at least some of the issues discussed above, as well as other possible issues. For example, it would be desirable to have a method and apparatus that takes into account difficulties and complexities with infusing aerospace structures.

### SUMMARY

An embodiment of the present disclosure provides a resin infusion tool. The resin infusion tool comprises a first tool portion of the resin infusion tool comprising a rigid material with a part infusion region and resin wells formed in the rigid material adjacent the part infusion region, and a second tool portion of the resin infusion tool comprising a rigid material and configured to seal to the first tool portion to form a part infusion chamber comprising the part infusion region.

Another embodiment of the present disclosure provides a method of infusing resin into a composite preform. Resin is placed into resin wells formed in a rigid material of a first tool portion of a resin infusion tool, the resin wells adjacent a part infusion region of the first tool portion. A second tool portion of the resin infusion tool comprising a rigid material is closed against the first tool portion to form a part infusion chamber containing a dry preform, the part infusion chamber comprising the part infusion region. The resin in the resin wells is heated to degas the resin. After degassing, the resin is infused into the dry preform by applying pressure to the resin in the resin wells using the second tool portion.

Yet another embodiment of the present disclosure provides a resin infusion tool. The resin infusion tool comprises a first tool portion, a second tool portion, flexible membranes, and a number of seals. The first tool portion of the resin infusion tool comprises a rigid material with a part infusion region, resin wells formed in the rigid material adjacent the part infusion region, and channels in the first tool portion connecting the resin wells to the part infusion region. The second tool portion of the resin infusion tool comprises a rigid material and configured to seal to the first tool portion to form a part infusion chamber comprising the part infusion region. The flexible membranes are attached to the second tool portion and configured to apply pressure to resin in the resin wells. The number of seals is connected to at least one of the first tool portion or the second tool portion and configured to seal the first tool portion to the second tool portion for an infusion process.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of an exploded view of a resin infusion tool in accordance with an illustrative embodiment;

FIG. 4 is an illustration of a bottom exploded view of a resin infusion tool in accordance with an illustrative embodiment;

FIG. 5 is an illustration of a top view of a first tool portion in accordance with an illustrative embodiment;

FIG. 6 is an illustration of an isometric view of a piece of a first tool portion in accordance with an illustrative embodiment;

FIG. 7 is an illustration of a bottom view of a second tool portion in accordance with an illustrative embodiment;

FIG. 8 is an illustration of an isometric view of a cross-section of a second tool portion in accordance with an illustrative embodiment;

FIG. 9 is an illustration of a cross-sectional view of a resin infusion tool in accordance with an illustrative embodiment;

FIG. 10 is an illustration of a cross-sectional view of a section of the resin infusion tool in accordance with an illustrative embodiment;

FIG. 11 is an illustration of a cross-sectional view of a section of the resin infusion tool during infusion in accordance with an illustrative embodiment;

FIG. 12 is an illustration of a cross-sectional view of a section of the resin infusion tool during infusion in accordance with an illustrative embodiment;

FIG. 13 is a flowchart of a method of infusing resin into a composite preform in accordance with an illustrative embodiment;

FIG. 14 is an illustration of an aircraft manufacturing and service method in a form of a block diagram in accordance with an illustrative embodiment; and

FIG. 15 is an illustration of an aircraft in a form of a block diagram in which an illustrative embodiment may be implemented.

### DETAILED DESCRIPTION

The illustrative examples recognize and take into account several considerations. The illustrative examples recognize and take into account that Resin Transfer Molding (RTM) processes for infusing dry fiber structures are often designed for high rate applications.

The illustrative examples recognize and take into account that for composite manufacturing for non-aerospace applications, a high rate in this capacity means constant. The illustrative examples recognize and take into account that part infusions and cures in minutes, such as tens, hundreds, or more small or medium sized parts a day.

The illustrative examples recognize and take into account that aerospace primary structure parts are very large. The illustrative examples recognize and take into account that large aerospace structures are made at a rate of at most four to six parts per day due to the size and complexity.

The illustrative examples recognize and take into account that cleaning of tanks and lines between every cycle is undesirably time consuming and non-value added. The illustrative examples recognize and take into account that cleaning is complicated by fact that distribution lines are heated, which means resin in lines is partially cured during the injection process. The illustrative examples recognize and take into account that injection machines add an additional complication to production flow: an additional piece of equipment for every press set, consumables, requires process monitoring on the production floor for resin process parameters.

The illustrative examples recognize and take into account that Controlled Atmospheric Pressure Resin Infusion (CAPRI) infusion is an alternative to resin transfer molding. The illustrative examples recognize and take into account that CAPRI infusion is not fast enough for high rate production. The illustrative examples recognize and take into account that CAPRI infusion can only have a maximum driving force behind resin of approximately half an atmosphere.

The illustrative examples recognize and take into account that CAPRI is a single-sided tool process. The illustrative examples recognize and take into account that some aerospace grade part quality standards call for closed mold tooling.

The illustrative examples recognize and take into account that it would be desirable to provide a resin infusion method and tooling that can enable high rate production. The illustrative examples recognize and take into account that it would be desirable to provide a resin infusion method and tooling that can enable at least one of increased infusion quality, reduced tool cleaning time, or faster part infusion.

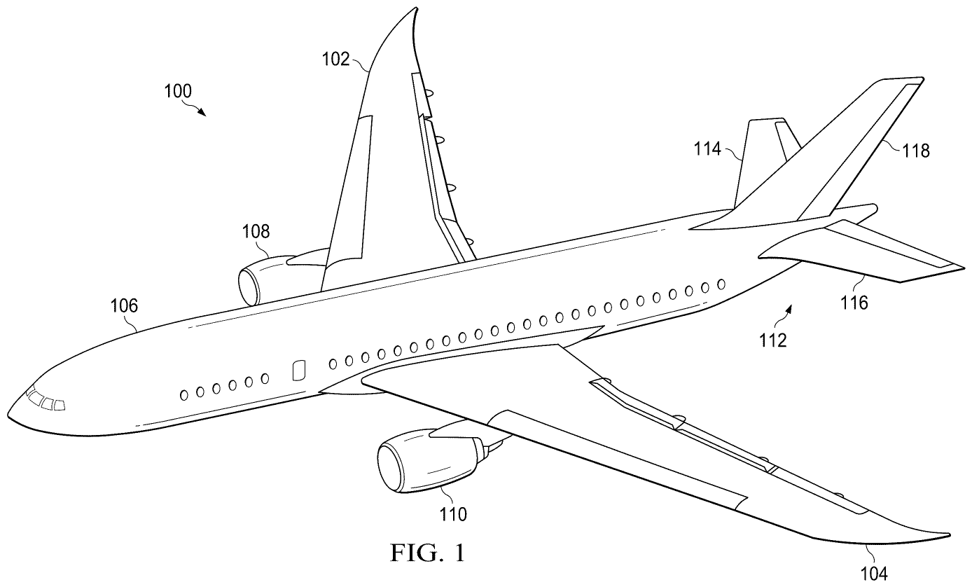

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have at least one composite structure manufactured using the resin infusion tool of the illustrative examples. For example, at least one of wing 102, wing 104, body 106, or a portion thereof can be manufactured using the resin infusion tool of the illustrative examples. Aircraft 100 is an example of an aircraft that can have at least one composite structure manufactured using method 1300.

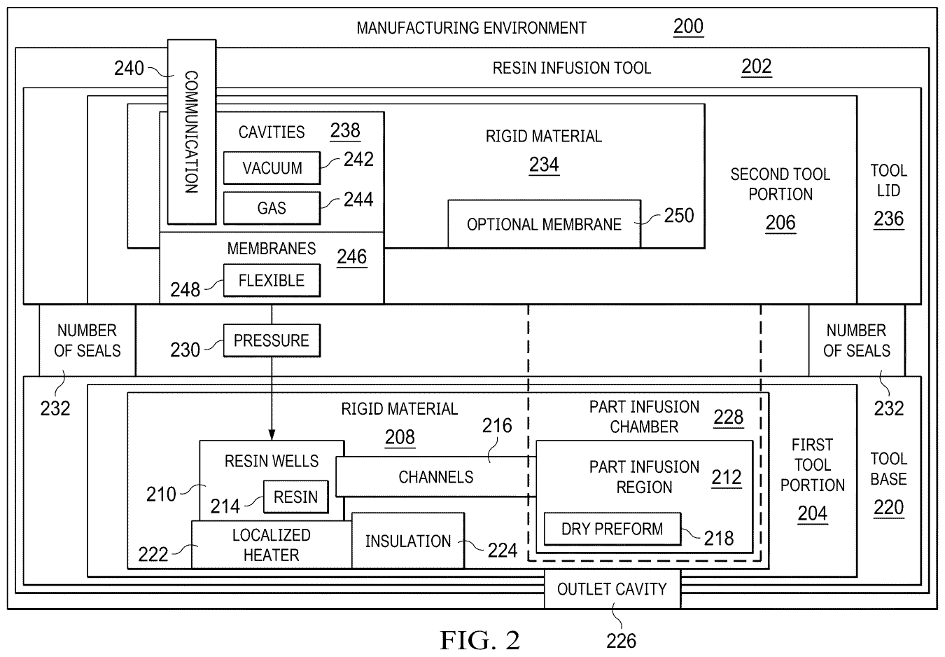

Turning now to FIG. 2, an illustration of a block diagram of a manufacturing environment is depicted in accordance with an illustrative embodiment. Resin infusion tool 202 in manufacturing environment 200 can be used to form a composite structure of aircraft 100 of FIG. 1.

Resin infusion tool 202 comprises first tool portion 204 of resin infusion tool 202 comprising rigid material 208 with part infusion region 212 and resin wells 210 formed in rigid material 208 adjacent part infusion region 212, and second tool portion 206 of resin infusion tool 202 comprising rigid material 234 and configured to seal to first tool portion 204 to form part infusion chamber 228 comprising part infusion region 212.

Resin wells 210 allow for introduction of resin 214 to resin infusion tool 202 prior to infusion of dry preform 218. Resin wells 210 allow for placing resin 214 into first tool portion 204 prior to sealing first tool portion 204 and second tool portion 206 to form resin infusion tool 202.

Resin wells 210 can be placed in areas which would be difficult to route through traditional resin transfer molding tooling. Drilled inlets can only go in one or two directions to allow for drilling and cleaning. Channels 216 could have complex geometry. Cleanout of channels 216 allows for ease of cleanout. Resin wells can be placed in ‘trapped’ areas, such as within a cutout. Resin 214 can be introduced to resin wells 210 as a pre-mixed resin. Resin 214 is placed into resin wells 210 as resin tablets.

As depicted, resin wells 210 are filled with resin 214. Resin 214 is pre-mixed before being placed into resin wells 210. Resin 214 takes any desirable form that can be handled and placed into resin wells 210. In some illustrative examples, placing resin 214 into resin wells 210 comprises placing pre-portioned resin tablets into resin wells 210. In this illustrative example, resin 214 can be described as resin tablets, resin pucks, or any other desirable reference to a pre-shaped and pre-portioned volume of resin 214.

In some illustrative examples, first tool portion 204 comprises tool base 220 of resin infusion tool 202.

Second tool portion 206 comprises cavities 238 configured to overlie resin wells 210 in an assembled position. Resin infusion tool 202 further comprises flexible 248 membranes 246 covering cavities 238. Cavities 238 have communication 240 outside of resin infusion tool 202 to at least one of a pressure source or a vacuum source. In some illustrative examples, vacuum 242 is introduced to cavities 238 during heating of resin 214 prior to infusion into dry preform 218. In some illustrative examples, gas 244 is introduced into cavities 238 to expand flexible 248 membranes 246 to apply pressure 230 to resin 214. In some illustrative examples, second tool portion 206 comprises tool lid 236 of resin infusion tool 202.

Resin infusion tool 202 further comprises channels 216 in first tool portion 204 between resin wells 210 and part infusion chamber 228, and connecting resin wells 210 to part infusion chamber 228. In some illustrative examples, at least one resin well of resin wells 210 is connected to multiple channels of channels 216. In some illustrative examples, at least one resin well of resin wells 210 is connected to another resin well of resin wells 210 by a spillway.

In some illustrative examples, each resin well of resin wells 210 have the same size and shape.

Number of seals 232 is connected to at least one of first tool portion 204 or second tool portion 206 and is configured to seal first tool portion 204 to second tool portion 206 for an infusion process.

In some illustrative examples, at least one localized heater 222 is positioned in first tool portion 204 to heat resin wells 210. In some illustrative examples, insulation 224 is positioned in first tool portion 204 to thermally isolate part infusion region 212 from resin wells 210.

In some illustrative examples, resin infusion tool 202 comprises first tool portion 204 of resin infusion tool 202 comprising rigid material 208 with part infusion region 212, resin wells 210 formed in rigid material 208 adjacent part infusion region 212, and channels 216 in first tool portion 204 connecting resin wells 210 to part infusion region 212; second tool portion 206 of resin infusion tool 202 comprises rigid material 234 and configured to seal to first tool portion 204 to form part infusion chamber 228 comprising part infusion region 212; flexible 248 membranes 246 attached to second tool portion 206 and configured to apply pressure 230 to resin 214 in resin wells 210; and number of seals 232 connected to at least one of first tool portion 204 or second tool portion 206 and configured to seal first tool portion 204 to second tool portion 206 for an infusion process. In this illustrative example, second tool portion 206 comprises cavities 238 in rigid material 234 configured to overlie resin wells 210 in an assembled position, and wherein flexible 248 membranes 246 extend over cavities 238.

Resin infusion tool 202 comprises strategically placed resin wells 210 defined within tool base 220. Resin wells 210 are in fluid communication with one another for directing vacuum pressures and resin flow into dry preform 218, which is a preform, are dry-fiber component. In some illustrative examples, pressure membranes, membranes 246 disposed within tool lid 236 and aligned with resin wells 210 to further enhance flow of resin 214. In some illustrative examples, resin infusion tool 202 includes integral heating, and each of resin wells 210 can include individual heat controls for optimizing timing and viscosity of resin flow.

Resin infusion tool 202 utilizes on-tool resin storage and distribution with vacuum assist. In resin infusion tool 202, resin wells 210 are integrated into resin infusion tool 202, along with resin distribution channels, channels 216. Resin 214 is loaded onto first tool portion 204 in solid or high viscosity form, but uncured. When loaded onto first tool portion 204, resin 214 is still able to melt and flow. During a heating process, resin 214 melts or lowers in viscosity, vacuum pressure forces resin 214 into dry preform 218 and then the resulting infused part cures at temperature.

Clean up of resin infusion tool 202 is simple as all resin 214 is completely cured and is easily removed from tool surfaces of resin infusion tool 202.

By utilizing pre-mixed resin, resin 214 is mixed in large batches in a facility designed for resin processing. Pre-mixed resin provides high levels of quality control and process monitoring possible and separated from the infusion cycle.

Resin Preparation (mixing) is separated from the infusion process. Mixing is performed at a batch level (maybe even off site by supplier) and can be monitored more regularly for quality. Undesirable quality in resin mixing can be identified prior to infusing resin 214 into dry preform 218.

Resin infusion tool 202 comprises two tooled surfaces for profile and surface quality management. Infusion using resin infusion tool 202 provides a high level of control of resin fiber volume. Infusion using resin infusion tool 202 provides high heating and cooling rates with integrally heated tooling. On tool resin storage using resin wells 210 simplifies production system for medium rate part fabrication.

Resin infusion tool 202 comprises two (or more) part tools. In this illustrative example, resin infusion tool 202 comprises two part tools, first tool portion 204 and second tool portion 206. Resin infusion tool 202 further comprises number of seals 232 and sealing surfaces. Compaction/Closing pressure is provided either by a standalone press or by pressure features integrated into the tool structure. Additional resin well features are integrated into the sealing plane, inside of first tool portion 204 in tool base 220 of resin infusion tool 202.

Resin wells 210 are designed to evenly heat resin 214 to a controlled temperature, without allowing reaction to proceed in an uncontrolled manner (exotherm). When resin infusion tool 202 is integrally heated, resin well area has a separate control/temperature circuit, so that a resin temperature, a temperature of resin 214, can be different from a part temperature of dry preform 218.

Dry preform 218 may be at a higher temperature for preform forming or drying. Insulation 224 in tool base 220 thermally isolates zones more effectively.

Resin wells 210 are connected to part infusion region 212 by a channel or channels of channels 216 which are above the surface of resin 214.

Resin 214 does not flow into dry preform 218 until driven by pressure 230. Channels 216 are open to vacuum 242 being drawn across dry preform 218 to assist with degassing of resin 214. In some illustrative examples, vacuum is drawn through outlet cavity 226. In some illustrative examples, resin wells 210 could have dedicated vacuum ports for degassing. In some illustrative examples, optional membrane 250 is present in second tool portion 206 to apply pressure over outlet cavity 226 during infusion of dry preform 218. Outlet cavity 226 starts off empty. Outlet cavity 226 can fill with resin 214 once dry preform 218 is filled with resin 214. Pressure can also be applied through the area of outlet cavity 226 as well using optional membrane 250.

Resin outlets can be strategically placed to drive infusion. Resin outlets can be similar to wells, but empty at the start of the infusion process. Outlet cavity 226 can act as a resin outlet.

Resin outlets could be closed off by pressure behind matching membrane, static vacuum, or active vacuum to assist with resin flow. Resin outlet membranes could initially be open, but then pressurized at appropriate stage in process to either drive resin flow or provide hydrostatic pressure to infused part.

Pressure drops through dry preform 218 as a function of distance from an injection point. Adding additional pressure locations can increase pressure uniformity throughout the entirety of resin infusion tool 202. Sensors in outlet cavities would be used to monitor flow of resin 214 through dry preform 218.

Resin infusion tool 202 can be referred to as resin on tool resin transfer molding tooling. Tool lid 236 integrates tooling surfaces and pressure membranes, membranes 246. Cavities 238 are recesses matching resin wells 210 machined into tool lid 236 and covered/closed with flexible 248 membranes 246.

Each resin well of resin wells 210 has one or more inlet channels of channels 216 into part infusion chamber 228 to infuse resin 214 into dry preform 218. Multiple inlet channels allows for increased control of resin flow or accelerated infusion by moving resin 214 faster to dry preform 218 or through more areas of dry preform 218.

Membranes 246 allow for controlled application of pressure 230 to resin 214 to drive resin flow into dry preform 218. Pressure 230 could be atmospheric or higher. Pressure 230 could come from air, inert gas, or liquid. Liquid at a higher temperature than resin 214 could be utilized if there is a benefit to quickly raising the temperature of the resin 214 for infusion. The benefits could include reducing viscosity or accelerating the cure cycle.

Discrete control of separate resin wells 210 and membranes 246 allows for controlled infusion of dry preform 218. In some illustrative examples, resin wells 210 could be pressurized sequentially if there was benefit of infusing some regions of dry preform 218 before others. In this illustrative example, tool lid 236 integrates discrete pressure controlling membranes 246 over resin wells 210.

In some illustrative examples, resin 214 can be prepared in a dedicated facility. Resin 214 and dry preform 218 are placed in cleaned and prepared tool base 220. Tool lid 236 is placed over tool base 220 and pressed to close resin infusion tool 202.

In some illustrative examples, vacuum leak checks can be performed for resin infusion tool 202. Heating of resin infusion tool 202 can begin to raise resin 214 to a degassing temperature and raise dry preform 218 to a preform drying temperature.

In some illustrative examples, a dwell is performed at the desired temperature(s) for degassing and drying. To begin infusion, membranes 246 over resin wells 210 are pressurized to drive resin 214 into dry preform 218. In some illustrative examples, membranes 246 are pressurized at different times to infuse dry preform 218. Membranes 246 and optionally optional membrane 250 are pressurized per an infusion process to provide a full infusion of dry preform 218. In some illustrative examples, a pressure sensor in the outlet cavity 226 can indicate resin 214 is present in outlet cavity 226.

In some illustrative examples, after infusion is complete, membranes 246 remain pressurized to maintain hydrostatic resin pressure in the infused part comprising resin 214 and dry preform 218. After infusing resin 214 into dry preform 218 to form the infused part, part cure can be performed. In some illustrative examples, to cure the infused part, resin infusion tool 202 heats to cure temperature (if different than infusion temperature).

In some illustrative example, after curing the infused part, resin infusion tool 202 is cooled to a part removal temperature. In some illustrative examples, after infusing and curing, the cured part is removed from resin infusion tool 202. After removal of the cured part, resin infusion tool 202 is cleaned of excess cured resin.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, although flexible membranes are described, other pressure applicators can be used. In some illustrative examples, mechanical applicators such as plungers could be utilized instead of flexible membranes.

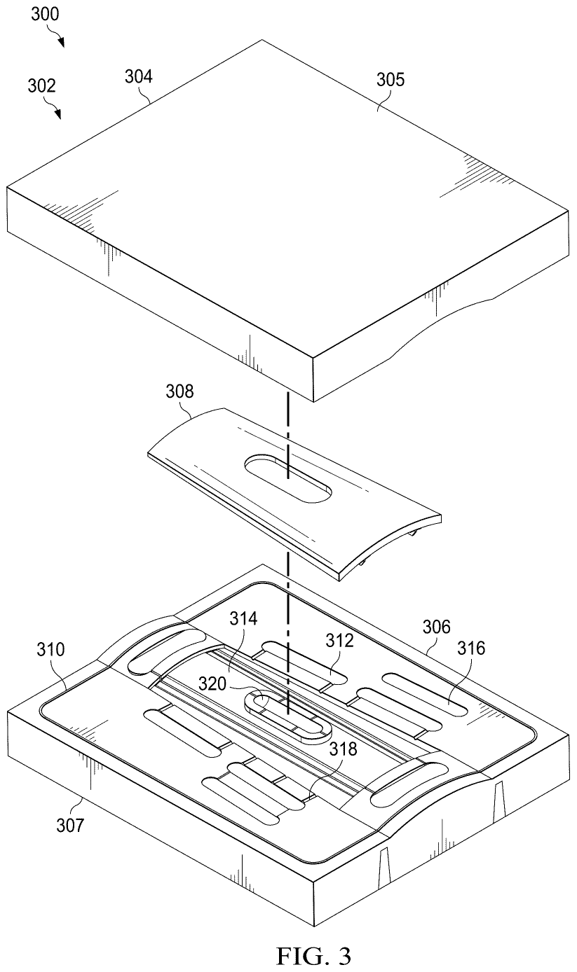

Turning now to FIG. 3, an illustration of an exploded view of a resin infusion tool is depicted in accordance with an illustrative embodiment. Resin infusion tool 302 can be used to manufacture a composite component of aircraft 100 of FIG. 1. Resin infusion tool 302 can be a physical implementation of resin infusion tool 202 of FIG. 2.

View 300 is an exploded view of resin infusion tool 302. Resin infusion tool 302 comprises first tool portion 306 of resin infusion tool 302 and second tool portion 304 of resin infusion tool 302. In this illustrative example, second tool portion 304 comprises tool lid 305. In this illustrative example, first tool portion 306 comprises tool base 307. First tool portion 306 comprises a rigid material with part infusion region 314 and resin wells 312 formed in the rigid material adjacent part infusion region 314. Second tool portion 304 of resin infusion tool 302 comprises a rigid material and is configured to seal to first tool portion 306 to form a part infusion chamber comprising part infusion region 314.

The resin infusion tool 302 further comprises number of seals 310 connected to at least one of first tool portion 306 or second tool portion 304 and configured to seal first tool portion 306 to second tool portion 304 for an infusion process. In this illustrative example, number of seals 310 comprises a seal connected to tool base 307.

Prior to infusing resin into dry preform 308, resin 316 is placed into resin wells 312, dry preform 308 is positioned into part infusion region 314, and tool lid 305 is sealed to tool base 307 using number of seals 310. As depicted, resin wells 312 are filled with resin 316. Resin 316 is pre-mixed before being placed into resin wells 312. Resin 316 takes any desirable form that can be handled and placed into resin wells 312. In some illustrative examples, placing resin 316 into resin wells 312 comprises placing pre-portioned resin tablets into resin wells 312. In this illustrative example, resin 316 can be described as resin tablets, resin pucks, or any other desirable reference to a pre-shaped and pre-portioned volume of resin.

In this illustrative example, resin wells 312 are distributed around part infusion region 314. Resin wells 312 can be positioned in any desirable locations to desirably distribute resin 316 to dry preform 308 that will be positioned in part infusion region 314. Positions of resin wells 312 are designed based on a size, shape, and thickness of dry preform 308. In some illustrative examples, at least one of a quantity of resin wells 312, positions of resin wells 312, or shapes of resin wells 312 are configured to efficiently infuse resin 316 into dry preform 308. As depicted, each resin well of resin wells 312 has the same size and shape. In other illustrative examples, at least one resin well of resin wells 312 can have a different size or shape than the remaining resin wells.

A part infusion chamber (not depicted) is formed by sealing tool lid 305 to tool base 307. The part infusion chamber comprises part infusion region 314. To infuse dry preform 308 with resin 316, resin 316 is heated and pressure is applied to resin 316. In this illustrative example, channels 318 in first tool portion 306 are between resin wells 312 and part infusion chamber (not depicted) and connect resin wells 312 to the part infusion chamber. Channels 318 in first tool portion 306 connect resin wells 312 to part infusion region 314. In some illustrative examples, at least one resin well of resin wells 312 is connected to multiple channels of channels 318.

Outlet cavity 320 can be used to evacuate part infusion region 314. In this illustrative example, outlet cavity 320 is formed within an opening of dry preform 308.

In some illustrative examples, vacuum is drawn through outlet cavity 320 to degas resin in resin wells 312. In some illustrative examples, resin wells 312 could have dedicated vacuum ports for degassing.

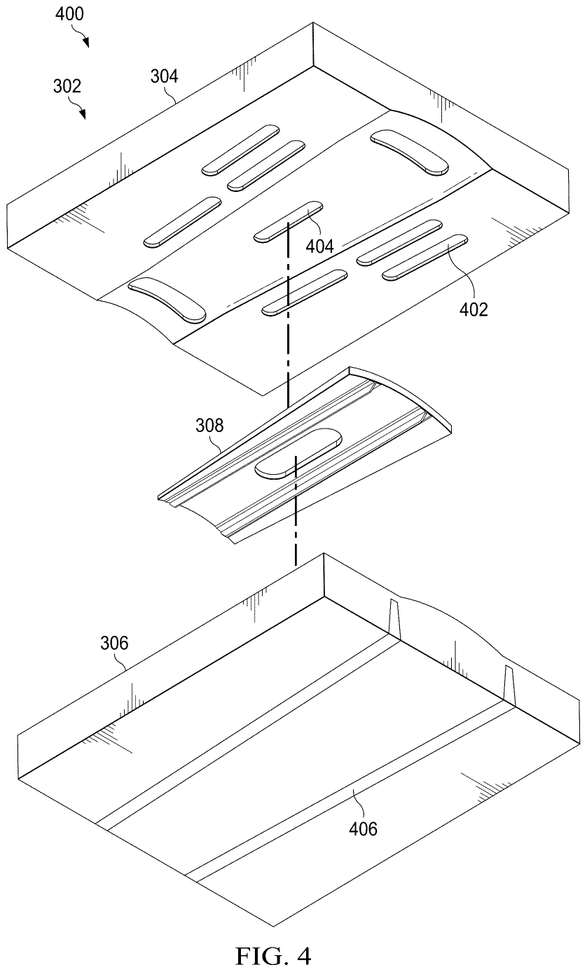

Turning now to FIG. 4, an illustration of a bottom exploded view of a resin infusion tool is depicted in accordance with an illustrative embodiment. View 400 is a bottom isometric view of resin infusion tool 302. Resin infusion tool 302 further comprises flexible membranes 402 connected to second tool portion 304. Flexible membranes 402 are configured to overlie resin wells 312 in FIG. 3 when tool lid 305 is sealed to tool base 307. Flexible membranes 402 cover cavities (not depicted) in second tool portion 304.

Flexible membranes 402 are configured to apply pressure to resin 316 in resin wells 312. Flexible membranes 402 can be expanded to apply pressure to resin 316 after heating resin 316. In this illustrative example, an additional flexible membrane, flexible membrane 404, is positioned in second tool portion 304 to cover outlet cavity 320 in first tool portion 306.

In some illustrative examples, resin infusion tool 302 comprises at least one localized heater (not depicted) positioned in first tool portion 306 to heat the resin wells, resin wells 312 of FIG. 3. In some illustrative examples, it is desirable to hold dry preform 308 at a different temperature than resin 316 of FIG. 3. In some illustrative examples, resin 316 of FIG. 3 is locally heated by at least one localized heater in first tool portion 306. In some illustrative examples, dry preform 308 is held at a lower temperature than resin 316 by thermally isolating part infusion region 314. In this illustrative example, resin infusion tool 302 comprises insulation 406 positioned in first tool portion 306 to thermally isolate part infusion region 314 from resin wells 312. In other illustrative examples, insulation 406 can take any desirable size, shape, position, or material in first tool portion 306.

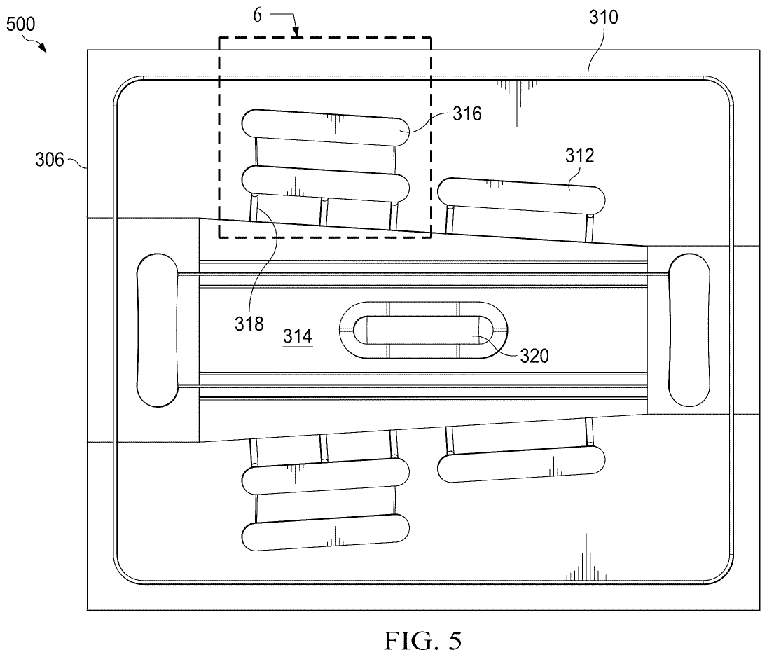

Turning now to FIG. 5, an illustration of a top view of a first tool portion is depicted in accordance with an illustrative embodiment. View 500 is a top view of first tool portion 306. Resin wells 312 and channels 318 are more clearly seen in view 500. Channels 318 may also be referred to as resin distribution troughs. Sizes, placement, and quantities of channels 318 are configured based on a desired resin infusion for dry preform 308 of FIG. 3. Multiple infusion troughs connected to each resin well of resin wells 312 move resin 316 quickly.

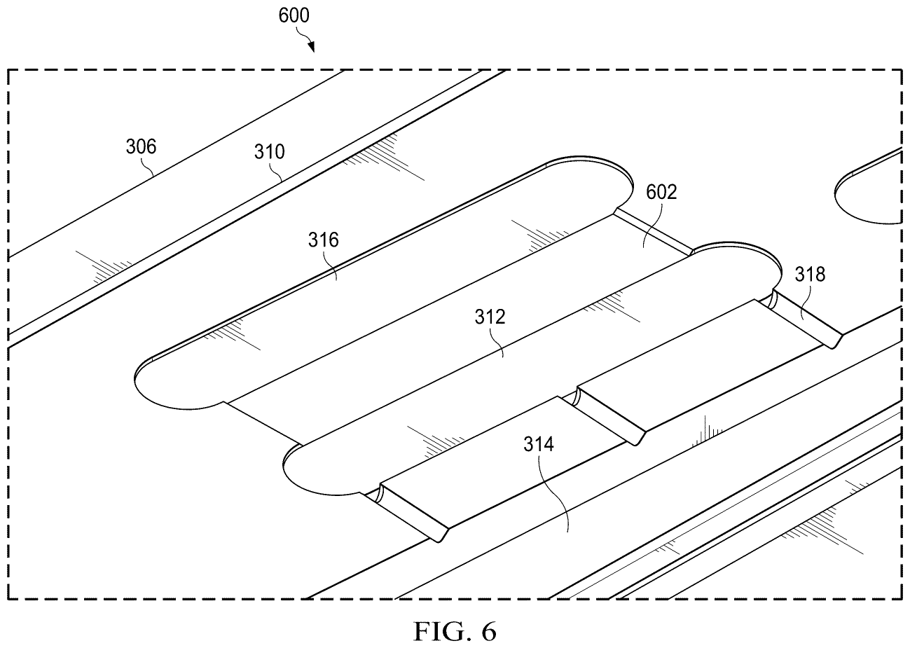

Turning now to FIG. 6, an illustration of an isometric view of a piece of a first tool portion is depicted in accordance with an illustrative embodiment.

View 600 is an isometric view within box 6 of FIG. 5. View 600 more clearly depicts spillway 602 connecting two resin wells of resin wells 312. Spillway 602 quickly moves resin 316 from one well to another (resin volume can only be so large before exotherm becomes a risk). Resin 316 is below a level of channels 318 prior to application of pressure.

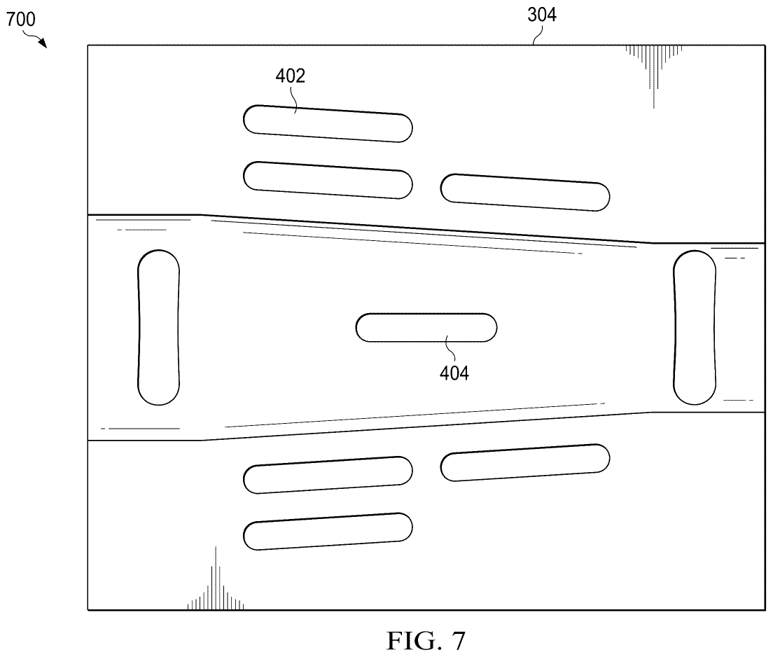

Turning now to FIG. 7, an illustration of a bottom view of a second tool portion is depicted in accordance with an illustrative embodiment. View 700 is a bottom view of second tool portion 304. Positions of membranes 402 connected to second tool portion 304 can be more clearly seen in view 700.

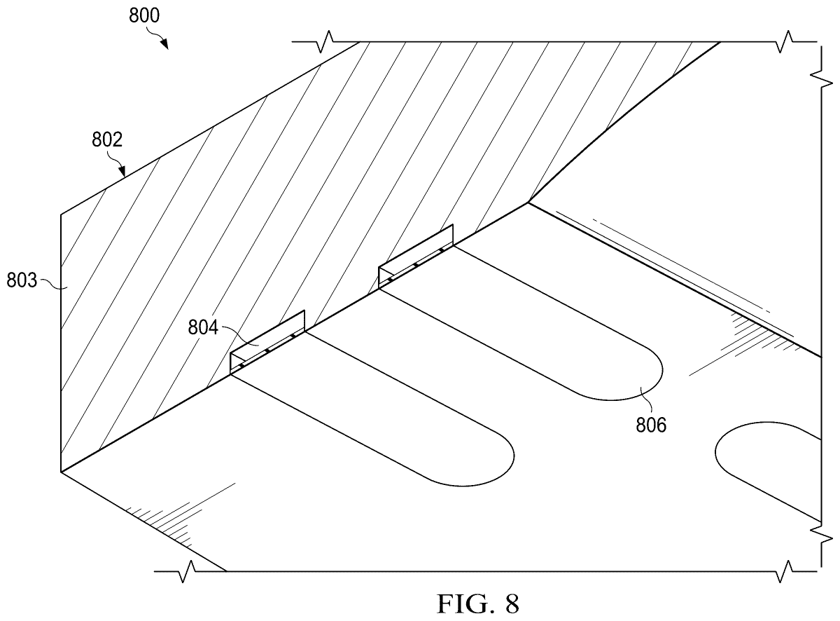

Turning now to FIG. 8, an illustration of an isometric view of a cross-section of a second tool portion is depicted in accordance with an illustrative embodiment. View 800 is a cross-sectional view of second tool portion 802. Second tool portion 802 can be the same as second tool portion 304 of FIGS. 3-7. Second tool portion 304 takes the form of tool lid 803. Second tool portion 802 comprises cavities 804. Membranes 806 are connected to second tool portion 802 and cover cavities 804. Each of membranes 806 can be controlled to desirably apply pressure to resin using membranes 806. In some illustrative examples, membranes 806 are individually controllable. In these illustrative examples, valves can individually control application of vacuum or positive pressure into each cavity of cavities 804.

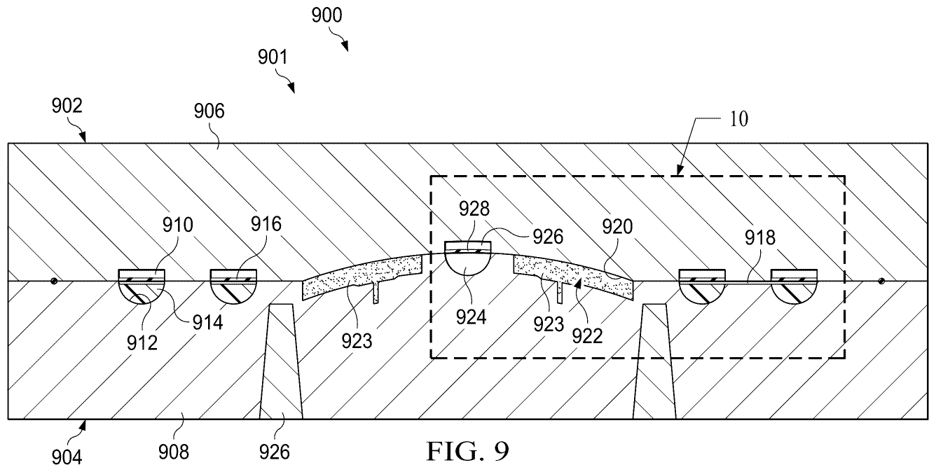

Turning now to FIG. 9, an illustration of a cross-sectional view of a resin infusion tool is depicted in accordance with an illustrative embodiment. View 900 is a cross-sectional view of an initial set-up of resin infusion tool 901 for resin infusion. In view 900, dry preform 923 is present in part infusion chamber 920. Part infusion chamber 920 is formed by sealing first tool portion 904 to second tool portion 902. Part infusion chamber 920 comprises part infusion region 922 in first tool portion 904. In this illustrative example, second tool portion 902 comprises tool lid 906. In this illustrative example, first tool portion 904 comprises tool base 908. Resin wells 912 are present in a rigid material of first tool portion 904. Resin 914 is present in resin wells 912. Cavities 910 are present in second tool portion 902. Cavities 910 overlie resin wells 912. Membranes 916 are connected to second tool portion 902. Membranes 916 cover cavities 910. Membranes 916 are configured to apply pressure to resin 914 during resin infusion. Spillway 918 connects resin wells 912.

Cavity 926 is present over outlet cavity 924. Outlet cavity 924 in first tool portion 904 is used to draw a vacuum in part infusion chamber 920. Vacuum drawn through outlet cavity 924 is provided for degassing resin 914 and drying dry preform 923. Resin wells 912 are connected to part infusion chamber 920 through spillway 918 and resin distribution channels for degassing of resin 914 after melting resin 914. Membrane 928 covers cavity 926 and can be used to apply pressure during resin infusion.

In FIG. 9, a lid of resin infusion tool 901, first tool portion 904, has been closed. Vacuum can be drawn on dry preform 923. Afterwards, resin infusion tool 901 is heated to degassing/preform drying temperature. In some illustrative examples, temperatures at resin wells 912 and dry preform 934 may be different depending on the process and material characteristics. Resin infusion tool 901 is sealed from outside environment.

Vacuum can be drawn behind flexible membranes 916 over resin wells 912. Resin wells 912 are connected to part infusion chamber 920 through spillways and resin distribution troughs for degassing of the liquid resin after melting. Vacuum can be drawn through outlet cavity 924 for degassing and preform drying.

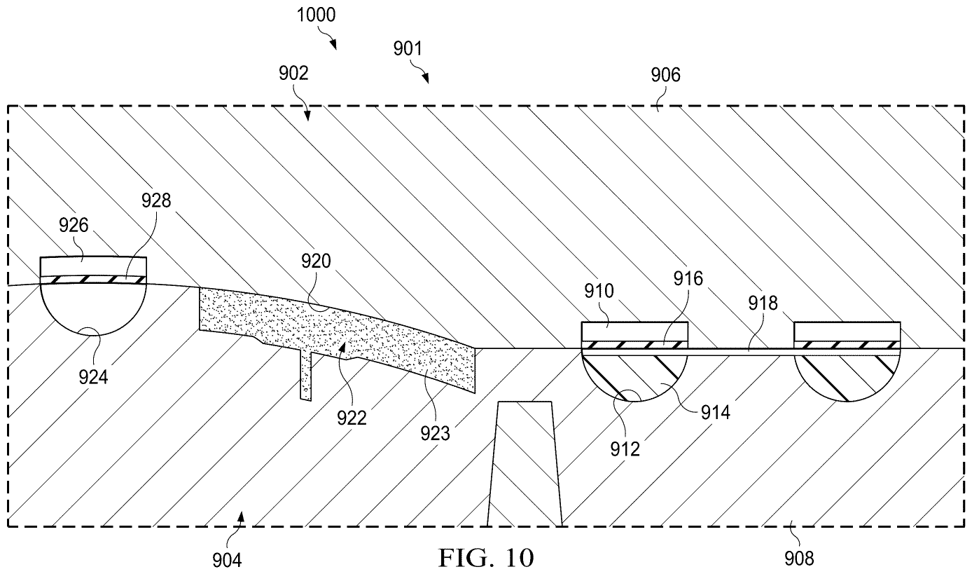

Turning now to FIG. 10, an illustration of a cross-sectional view of a section of the resin infusion tool is depicted in accordance with an illustrative embodiment. View 1000 is a view in box 10 of FIG. 9. View 1000 is a closer view of one side of resin infusion tool 901 prior to resin infusion. View 1000 is a view after closing tool lid 906. Resin infusion tool 901 is sealed from the outside environment. Vacuum is drawn on dry preform 923. Resin 914 in resin infusion tool 901 is heated to a degassing temperature. Dry preform 923 is heated to a preform drying temperature. In some illustrative examples, the temperature for resin 914 and dry preform 923 are different.

In some illustrative examples, during heating, vacuum is drawn behind flexible membranes 916 over resin wells 912. Resin wells 912 are connected to the preform cavity, part infusion chamber 920, through spillways and resin distribution channels/troughs for degassing of liquid resin 914 after melting.

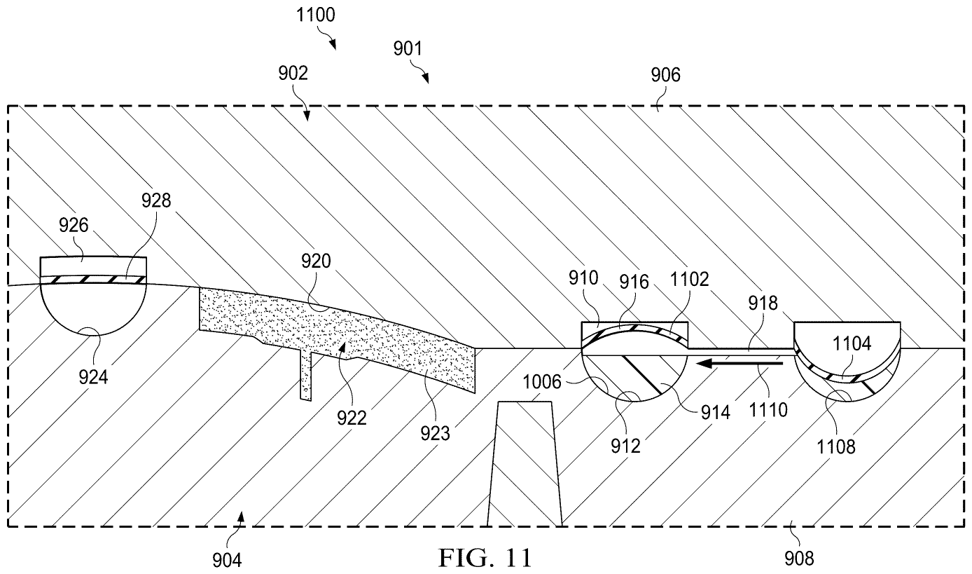

Turning now to FIG. 11, an illustration of a cross-sectional view of a section of the resin infusion tool during infusion is depicted in accordance with an illustrative embodiment. View 1100 is a view of beginning infusion. In view 1100, flexible membranes 916 are being used to selectively apply pressure to resin 914 in resin wells 912. Flexible membranes 916 comprise flexible membrane 1102 and flexible membrane 1104. Flexible membrane 1102 is positioned over resin 914 in resin well 1106. Flexible membrane 1104 is positioned over resin 914 in resin well 1108.

In view 1100, pressure is applied by flexible membrane 1104 to resin 914 in resin well 1108. Pressure has been introduced to the cavity behind flexible membrane 1104 to expand flexible membrane 1104 into resin well 1108. A vacuum is still pulled in the cavity behind flexible membrane 1102. By applying pressure by flexible membrane 1104 while pulling vacuum in outlet cavity 924, resin flow 1110 occurs. Resin flow 1110 is through spillway 918 towards resin well 1106.

In view 1100, pressure differential is utilized to drive resin 914 into dry preform 934. Pressure over flexible membranes 916 can be timed to drive resin 914 into dry preform 934.

Vacuum can be maintained in some areas and then the pressure can be sequentially introduced for desired resin flow. Actuation may not necessarily be sequential. Actuation can be timed to drive resin for a desired infusion of dry preform 934.

Grooves in resin infusion tool 901 can be present to flow resin 914 into hard to reach places, such as in blade stringers. Vacuum can be maintained in cavity 926 with membrane 928 over outlet cavity 924 to assist with driving resin 914 through dry preform 934.

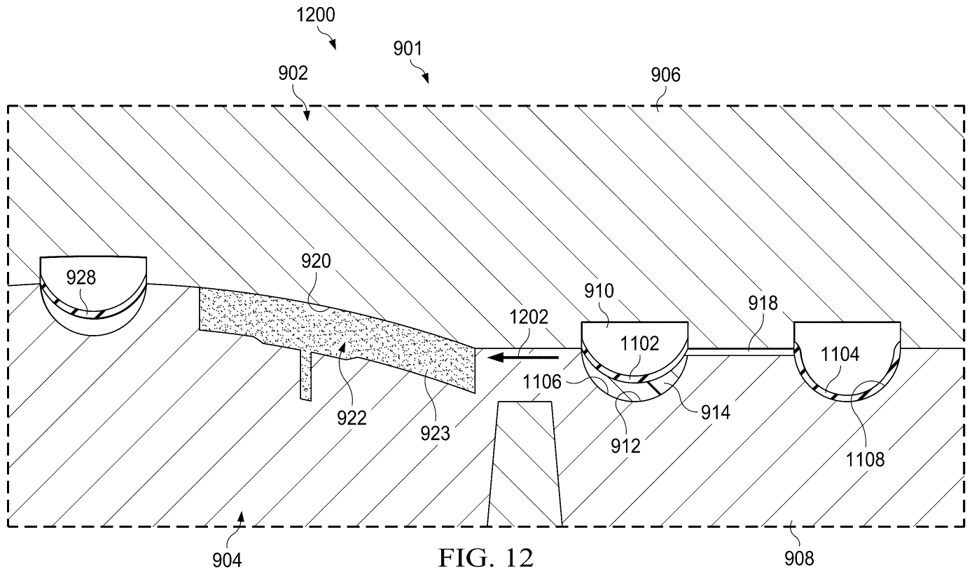

Turning now to FIG. 12, an illustration of a cross-sectional view of a section of the resin infusion tool during infusion is depicted in accordance with an illustrative embodiment. In view 1200, pressure has been applied by flexible membranes 916 to infuse resin 914 into dry preform 923. In view 1200, resin 914 has traveled out of resin well 1108 and into resin well 1106. In view 1200, pressure by flexible membrane 1104 drove infusion of resin 914. As depicted, flexible membrane 1102 has been pressurized to press resin from resin well 1106. By applying pressure by flexible membrane 1102 while pulling vacuum in outlet cavity 924, resin flow 1202 occurs. Resin flow 1202 is out of resin well 1106 and into part infusion chamber 920.

In some illustrative examples, view 1200 is a view of the end of infusion of resin 914. In this illustrative example, pressure is maintained on resin 914.

After all membranes 916 over resin wells 912 have pressurized, driving resin 914 into dry preform 923, resin 914 will begin to enter outlet cavity 924. Once resin 914 is sensed via pressure sensor or other manner in outlet cavity 924, pressure can be applied above membrane 928 for backpressure into part infusion chamber 920.

Backpressure on resin 914 in dry preform 923 at the end of infusion can mitigate undesirable quality caused by resin shrinkage during cure. After the cure cycle is complete, resin infusion tool 901 will be opened, the cured part will be removed, and cured excess resin will be cleaned from channels and resin wells 912.

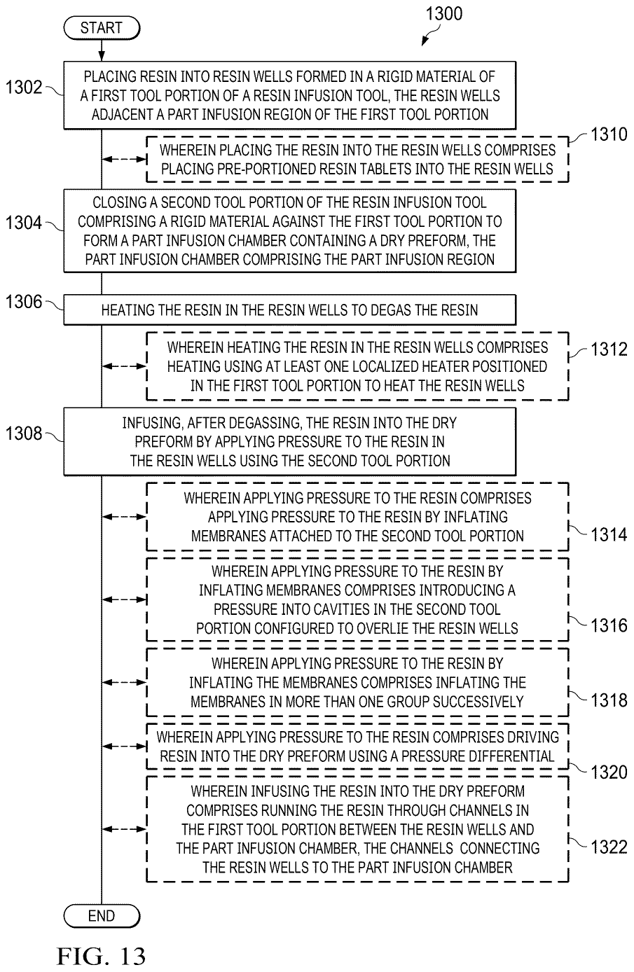

Turning now to FIG. 13, a flowchart of a method of infusing resin into a composite preform is depicted in accordance with an illustrative embodiment. Method 1300 can be performed to manufacture a composite component of aircraft 100 of FIG. 1. Method 1300 can be performed using resin infusion tool 202 of FIG. 2. Method 1300 can be performed using resin infusion tool 302 of FIGS. 3-7. Method 1300 can be performed using second tool portion 802 of FIG. 8. Method 1300 can be performed using resin infusion tool 901 of FIGS. 9-12.

Method 1300 places resin into resin wells formed in a rigid material of a first tool portion of a resin infusion tool, the resin wells adjacent a part infusion region of the first tool portion (operation 1302). Method 1300 closes a second tool portion of the resin infusion tool comprising a rigid material against the first tool portion to form a part infusion chamber containing a dry preform, the part infusion chamber comprising the part infusion region (operation 1304). Method 1300 heats the resin in the resin wells to degas the resin (operation 1306). Method 1300 infuses, after degassing, the resin into the dry preform by applying pressure to the resin in the resin wells using the second tool portion (operation 1308). Afterwards, method 1300 terminates.

In some illustrative examples, vacuum is pulled across the resin wells during the heating to degas the resin. In some illustrative examples, vacuum is applied to the part infusion chamber prior to heating. In some illustrative examples, vacuum is applied to the part infusion chamber during degas and during resin infusion.

In some illustrative examples, placing the resin into the resin wells comprises placing pre-portioned resin tablets into the resin wells (operation 1310). In some illustrative examples, the pre-portioned resin tablets are the same size and shape.

In some illustrative examples, heating the resin in the resin wells comprises heating using at least one localized heater positioned in the first tool portion to heat the resin wells (operation 1312). In some illustrative examples, each resin well of the resin wells is independently heated based on a desired infusion process.

In some illustrative examples, applying pressure to the resin comprises applying pressure to the resin by inflating membranes attached to the second tool portion (operation 1314). In some illustrative examples, applying pressure to the resin by inflating membranes comprises introducing a pressure into cavities in the second tool portion configured to overlie the resin wells (operation 1316). In some illustrative examples, applying pressure to the resin by inflating the membranes comprises inflating the membranes in more than one group successively (operation 1318). In some illustrative examples, applying pressure to the resin comprises driving resin into the dry preform using a pressure differential (operation 1320).

In some illustrative examples, infusing the resin into the dry preform comprises running the resin through channels in the first tool portion between the resin wells and the part infusion chamber, the channels connecting the resin wells to the part infusion chamber (operation 1322). In some illustrative examples, infusing the resin into the dry preform comprises running resin into a spillway between adjacent resin wells.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1310 through operation 1322 may be optional.

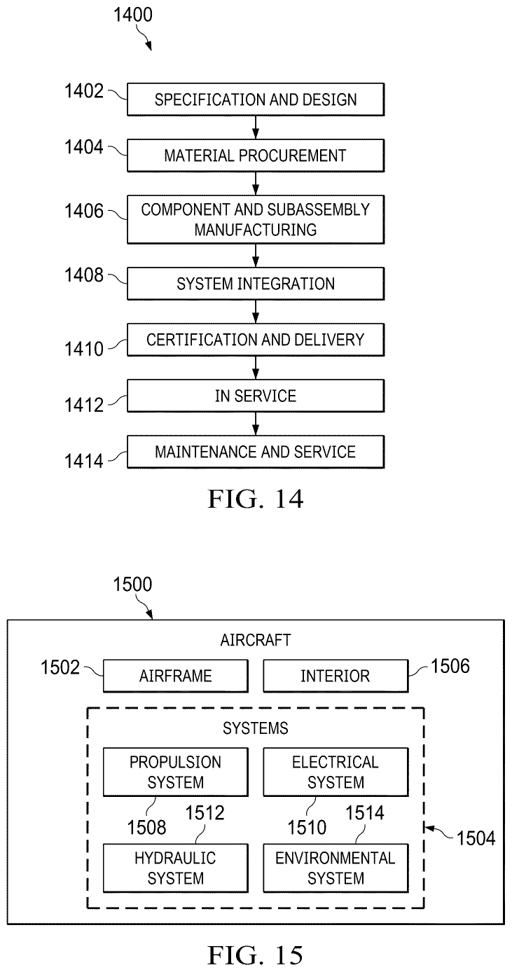

Illustrative embodiments of the present disclosure may be described in the context of aircraft manufacturing and service method 1400 as shown in FIG. 14 and aircraft 1500 as shown in FIG. 15. Turning first to FIG. 14, an illustration of an aircraft manufacturing and service method in a form of a block diagram is depicted in accordance with an illustrative embodiment. During pre-production, aircraft manufacturing and service method 1400 may include specification and design 1402 of aircraft 1500 in FIG. 15 and material procurement 1404.

During production, component and subassembly manufacturing 1406 and system integration 1408 of aircraft 1500 takes place. Thereafter, aircraft 1500 may go through certification and delivery 1410 in order to be placed in service 1412. While in service 1412 by a customer, aircraft 1500 is scheduled for routine maintenance and service 1414, which may include modification, reconfiguration, refurbishment, or other maintenance and service.

Each of the processes of aircraft manufacturing and service method 1400 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 15, an illustration of an aircraft in a form of a block diagram is depicted in which an illustrative embodiment may be implemented. In this example, aircraft 1500 is produced by aircraft manufacturing and service method 1400 of FIG. 14 and may include airframe 1502 with plurality of systems 1504 and interior 1506. Examples of systems 1504 include one or more of propulsion system 1508, electrical system 1510, hydraulic system 1512, and environmental system 1514. Any number of other systems may be included.

Apparatuses and methods embodied herein may be employed during at least one of the stages of aircraft manufacturing and service method 1400. One or more illustrative embodiments may be manufactured or used during at least one of component and subassembly manufacturing 1406, system integration 1408, in service 1412, or maintenance and service 1414 of FIG. 14.

The illustrative examples provide a process and system for infusing dry fiber structures during high-rate manufacturing applications. The illustrative examples provide a system comprising mating tooling configured to define a closed, air-tight mold cavity, when fitted together. The illustrative examples provide tooling that comprises at least one base tool defining a plurality of resin wells, and several channels fluidly connecting the resin wells. Each of the resin wells may be individually heated, independent of the integrally heated tooling, to optimize timing and flow of resin into a structural preform. A predefined mixture of resin is loaded into each of the resin wells in a high-viscosity, but un-cured form which melts to a lower-viscosity at a predefined time to flow into the preform under vacuum pressure within the tooling. Pressure membranes are coupled to the tooling lid and aligned with each of the resin wells for applying predefined individual forces to the resin wells to further enhance flow. In some illustrative examples, the tooling base can further include insulation to help isolate heat between the resin wells. The illustrative examples provide a high-rate solution for producing high-quality structural components via resin infusion of dry fiber preforms, using pre-mixed, un-cured resin blocks that are strategically melted through the process for optimizing resin flow into the component and preventing exotherm reactions from the resin. The illustrative examples will significantly improve part quality and help to increase rates associated with resin infusion processes.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A resin infusion tool comprising:
a first tool portion of the resin infusion tool comprising a rigid material with a part infusion region and resin wells formed in the rigid material adjacent the part infusion region; and
a second tool portion of the resin infusion tool comprising a rigid material and configured to seal to the first tool portion to form a part infusion chamber comprising the part infusion region.

2. The resin infusion tool of claim 1, wherein the second tool portion comprises cavities configured to overlie the resin wells in an assembled position, and the resin infusion tool further comprising:
flexible membranes covering the cavities.

3. The resin infusion tool of claim 1 further comprising:
channels in the first tool portion between the resin wells and the part infusion chamber and connecting the resin wells to the part infusion chamber.

4. The resin infusion tool of claim 3, wherein at least one resin well of the resin wells is connected to multiple channels of the channels.

5. The resin infusion tool of claim 1 further comprising:
a number of seals connected to at least one of the first tool portion or the second tool portion and configured to seal the first tool portion to the second tool portion for an infusion process.

6. The resin infusion tool of claim 1, wherein the first tool portion comprises a tool base of the resin infusion tool.

7. The resin infusion tool of claim 1, wherein the second tool portion comprises a tool lid of the resin infusion tool.

8. The resin infusion tool of claim 1, wherein each resin well of the resin wells have the same size and shape.

9. The resin infusion tool of claim 1, further comprising:
at least one localized heater positioned in the first tool portion to heat the resin wells.

10. The resin infusion tool of claim 1, further comprising:
insulation positioned in the first tool portion to thermally isolate the part infusion region from the resin wells.

11. A method of infusing resin into a composite preform comprising:
placing resin into resin wells formed in a rigid material of a first tool portion of a resin infusion tool, the resin wells adjacent a part infusion region of the first tool portion;
closing a second tool portion of the resin infusion tool comprising a rigid material against the first tool portion to form a part infusion chamber containing a dry preform, the part infusion chamber comprising the part infusion region;
heating the resin in the resin wells to degas the resin; and
infusing, after degassing, the resin into the dry preform by applying pressure to the resin in the resin wells using the second tool portion.

12. The method of claim 11, wherein applying pressure to the resin comprises applying pressure to the resin by inflating membranes attached to the second tool portion.

13. The method of claim 12, wherein applying pressure to the resin by inflating membranes comprises introducing a pressure into cavities in the second tool portion configured to overlie the resin wells.

14. The method of claim 12, wherein applying pressure to the resin by inflating the membranes comprises inflating the membranes in more than one group successively.

15. The method of claim 11, wherein applying pressure to the resin comprises driving resin into the dry preform using a pressure differential.

16. The method of claim 11, wherein placing the resin into the resin wells comprises placing pre-portioned resin tablets into the resin wells.

17. The method of claim 11, wherein heating the resin in the resin wells comprises heating using at least one localized heater positioned in the first tool portion to heat the resin wells.

18. The method of claim 11, wherein infusing the resin into the dry preform comprises running the resin through channels in the first tool portion between the resin wells and the part infusion chamber, the channels connecting the resin wells to the part infusion chamber.

19. A resin infusion tool comprising:
a first tool portion of the resin infusion tool comprising a rigid material with a part infusion region, resin wells formed in the rigid material adjacent the part infusion region, and channels in the first tool portion connecting the resin wells to the part infusion region;
a second tool portion of the resin infusion tool comprising a rigid material and configured to seal to the first tool portion to form a part infusion chamber comprising the part infusion region;
flexible membranes attached to the second tool portion and configured to apply pressure to resin in the resin wells; and
a number of seals connected to at least one of the first tool portion or the second tool portion and configured to seal the first tool portion to the second tool portion for an infusion process.

20. The resin infusion tool of claim 19, wherein the second tool portion comprises cavities in the rigid material configured to overlie the resin wells in an assembled position, and wherein the flexible membranes extend over the cavities.
